(19) United States
(12) Patent Application Publication
(10) Pub. No.: US 2021/0381089 A1
(43) Pub. Date: Dec. 9, 2021

(54) SUPER SOFT MAGNETIC FE-BASED AMORPHOUS ALLOY

(71) Applicants: BMG Co., Ltd., Miyagi (JP); GUANGZHOU LOCONTECH CO., LTD, GUANGZHOU CITY (CN)

(72) Inventors: Akihisa Inoue, Togane-shi (JP); Erzhena Zanaeva, Moscow (RU); Andray Bazlov, Moscow (RU); Alexander Churyumov, Moscow (RU); Fanli Kong, Togane-shi (JP)

(21) Appl. No.: 17/128,742

(22) Filed: Dec. 21, 2020

(30) Foreign Application Priority Data
Jun. 8, 2020 (JP) 2020-099552

(51) Int. Cl. C22C 45/00; H01F 1/153

(52) U.S. Cl. CPC C22C 45/008; C22C 2200/02; C22C 2202/02; H01F 1/15308

(57) ABSTRACT

According to the present invention, provided is a super soft magnetic Fe-based amorphous alloy represented by a composition formula of the following formula (I):

(Fe_{1-X}Ni_{X})ₐB_{b}P_{c}Si_{d}Cₑ (I)
wherein 0.45≤X≤0.65,
a, b, c, d, and e each represent atomic %, 78≤a≤82, 10≤b≤13, 3≤c≤5, 2≤d≤4, 0.5≤e≤1, and a+b+c+d+e=100.

### CROSS-REFERENCE TO RELATED APPLICATIONS

The present application claims priority under 35 U.S.C. 119 to Japanese Patent Application No. 2020-099552, filed on Jun. 8, 2020. The above application is hereby expressly incorporated by reference, in its entirety, into the present application.

### BACKGROUND OF THE INVENTION

The present invention relates to a super soft magnetic Fe-based amorphous alloy. More specifically, the present invention relates to a super soft magnetic Fe-based amorphous alloy having a low coercive force and a high saturation magnetic flux density, and also having an extremely excellent effective magnetic permeability. The super soft magnetic Fe-based amorphous alloy of the present invention can be suitably applied to low loss inductors (for example, ultra high frequency inductors for smartphones of 100 kHz or more, etc.), magnetic sensors, magnetic shields, magnetic antennas, and the like.

Conventionally, in various alloy systems, amorphous alloys having an amorphous structure in which atoms are randomly arranged have been found, and various products that take advantages of high strength due to the atomic arrangement, good soft magnetic properties, chemical stability, and the like have been developed. These amorphous alloys can usually be prepared by a method of quenching an alloy molten metal to produce a thin strip or the like (liquid quenching method), a method of vapor deposition from a vapor phase, or the like. It is known that when an amorphous alloy having a specific composition is heated, it transitions to a supercooled liquid state before crystallization start temperature is reached, causing a rapid decrease in viscosity. Such an amorphous alloy of a composition having a wide supercooled liquid state in a temperature region lower than the crystallization start temperature is known as a so-called metal glass alloy. The metal glass alloy exhibits excellent soft magnetic properties, and is capable of forming a bulky thick plate material that is much thicker than the thin strip of the amorphous soft magnetic alloy obtained by the liquid quenching method, and a wide range of applications have been realized. Recently, active research and development have been conducted to further improve performance of such metal glass alloys (JP 9-320827 A, JP 2001-254159 A, JP 2002-105607 A, JP 2009-120927 A, and JP 2014-31534 A).

### SUMMARY OF THE INVENTION

The present invention has been made in view of the above conventional circumstances, and an object thereof is to provide a super soft magnetic Fe-based amorphous alloy having a low coercive force and a high saturation magnetic flux density, and also having an extremely excellent effective magnetic permeability.

In order to achieve the above object, the present invention provides a super soft magnetic Fe-based amorphous alloy represented by a composition formula of the following formula (I):

(Fe_{1-X}Ni_{X})ₐB_{b}P_{c}Si_{d}Ce (I)

wherein 0.45 X 0.65,

a, b, c, d, and e each represent atomic %, 78≤a≤82, 10≤b≤13, 3≤5, 2≤4, 0.5≤e≤1, and a+b+c+d+e=100.

Here, it is preferable that B/Si is 3 to 6 (atomic % ratio) in the formula (I).

In addition, it is preferable that (B+P+C)/Si is 4 to 8 (atomic % ratio) in the formula (I).

Further, it is preferable that (B+C)/(P+Si) is larger than 1.4 (atomic % ratio) in the formula (I).

Further, it is preferable that the super soft magnetic Fe-based amorphous alloy has an effective magnetic permeability (μe (1 kHz)) of 50,000 or more.

Further, it is preferable that the super soft magnetic Fe-based amorphous alloy has a glass transition temperature (Tg) in a region lower than crystallization start temperature (Tx) in heat treatment.

The present invention provides a super soft magnetic Fe-based amorphous alloy having a low coercive force and a high saturation magnetic flux density, and also having an extremely excellent effective magnetic permeability.

### DETAILED DESCRIPTION OF THE INVENTION

Hereinafter, the present invention will be described in detail.

The super soft magnetic Fe-based amorphous alloy according to the present invention is represented by a composition formula of the following formula (I).

(Fe_{1-X}Ni_{X})ₐB_{b}P_{c}Si_{d}C (I)

In the above formula (I), 0.45≤X≤0.65.

In the above formula (I), a, b, c, d, and e each represent atomic %, 78≤a≤82, 10≤b≤13, 3≤c≤5, 2≤d≤4, 0.5≤e≤1, and a+b+c+d+e=100.

In the present invention, by setting values of a, b, c, d, e, and X within the above ranges, respectively, in the above formula (I), the alloy can have effects of having a low coercive force and a high saturation magnetic flux density, and also having an extremely excellent effective magnetic permeability. When any of the values deviates from the above range, the alloy cannot have the above-mentioned effect of the present invention. In the present invention, the high saturation magnetic flux density also includes an appropriately high saturation magnetic flux density of 0.6 T or more.

In the present invention, particularly, an Fe-based amorphous alloy containing Fe and Ni is characterized in that it has a multi-metalloid composition in which metalloids B and Si are combined at a specific blending ratio, and these metalloids are blended within a predetermined range. Specifically, in the above formula (I), B/Si is 3 to 6 (atomic % ratio), and more preferably 4 to 5 (atomic % ratio). By blending B and Si in the above ratio, an amorphous phase showing a glass transition in a high Ni concentration and high (Fe+Ni) concentration alloy is obtained.

Moreover, in the above formula (I), in terms of an amorphous alloy forming ability showing a glass transition, (B+P+C)/Si is preferably 4 to 8 (atomic % ratio), and more preferably 6 to 8 (atomic % ratio).

Further, in the above formula (I), in terms of an amorphous forming ability showing a glass transition, (B+C)/(P+Si) is preferably larger than 1.4 (atomic % ratio), and more preferably 1.6 to 1.9 (atomic % ratio).

The Fe-based amorphous alloy of the present invention represented by the composition formula of the above formula (I) is so-called metal glass, and has a glass transition point in a lower temperature region than the crystallization start temperature (Tx) (=glass transition temperature (Tg)) in heat treatment. The temperature region between the crystallization start temperature (Tx) and the glass transition temperature (Tg) is called a supercooled liquid region and is considered to be related to stabilization of a glass structure of the metal glass. Unlike amorphous alloys having no supercooled liquid region, alloys of these compositions do not require an extremely large cooling rate when forming a glass structure, and thus, it is possible to prepare a metal glass bulk material with a thickness of about several millimeters.

The super soft magnetic Fe-based amorphous alloy according to the present invention of the above constitution can be prepared by a conventionally used method.

For example, an alloy of the composition represented by the above formula (I) in a molten state (alloy molten metal) is cooled and solidified by a single copper alloy roll quenching method to produce an amorphous alloy thin strip of a thin strip (ribbon shape) filament. Alternatively, the amorphous alloy film is formed by a vapor phase quenching method such as a sputtering method or a vapor method. When the single roll method is adopted, the alloy molten metal may be quenched in an inert gas atmosphere, a vacuum atmosphere, or an air atmosphere. In the case of the roll quenching method, the roll peripheral speed is preferably about 30 to 40 m/s, but it is not particularly limited.

Subsequently, the above-mentioned thin strip is annealed. Annealing temperature is preferably (Tg-10) K to (Tg-40) K, and more preferably (Tg-20) K to (Tg-30) K.

Annealing time is preferably about 5 to 45 minutes, and more preferably about 10 to 30 minutes. The annealing atmosphere is not particularly limited, and examples thereof include a vacuum atmosphere, an argon atmosphere, a nitrogen atmosphere, and the like.

The super soft magnetic Fe-based amorphous alloy of the present invention thus obtained has an excellent effect of showing a saturation magnetic flux density (Bs) of 0.6 T or more.

Also, the coercive force (Hc) can be suppressed to a low value of 1 A/m or less.

Further, it is possible to obtain an extremely excellent effect of having an effective magnetic permeability (1 kHz) of 50,000 (μe) or more.

The amorphous alloy of the present invention is in the form of “metal glass”. In the present invention, the “metal glass” refers to a state that an X-ray diffraction pattern obtained by measuring an alloy by a usual X-ray diffraction method has only a broad peak (glass phase) and does not have a sharp peak.

When the temperature of the amorphous alloy of the present invention is raised, a rapid softening associated with the glass transition phenomenon is observed. This softening phenomenon is a phenomenon peculiar to metal glass, and can be processed into various shapes within a time range until crystallization starts by performing heating to a glass transition temperature (Tg) or higher. The glass transition phenomenon can be measured by various methods such as thermomechanical analysis (TMA), and the Fe-based metal glass of the present invention can be processed by selecting a temperature suitable for a processing method of a member. In the Fe-based metal glass of the present invention (metal glass single phase), a temperature interval of the supercooled liquid region represented by a formula of temperature difference ΔTx between the crystallization start temperature (Tx) and the glass transition temperature (Tg) (ΔTx=Tx-Tg) shows usually 15 K or more and preferably 20 K or more when measured at a temperature rising rate of 40 K/min.

Incidentally, heat treatment of the sample applied to obtain the amorphous alloy of the present invention is not particularly limited, and examples thereof include a method of performing conventional vacuum sealing, putting it in a heat treatment furnace, rapidly raising the temperature and quenching the sample.

However, in the case of a material showing super soft magnetism like the amorphous alloy of the present invention, it is preferable to wrap the sample in aluminum or copper foil, put it into ash powder, carbon powder, fine sand, or fine iron oxide powder heated to a predetermined temperature in advance, and perform heat treatment, as compared with the conventional heat treatment method described above. By performing such a heat treatment, it becomes possible to perform heating to a predetermined temperature at a much more rapid heating rate and to finish the heating quickly.

As a result, in the super soft magnetic Fe-based amorphous alloy of the present invention, precise temperature control enables short-time heat treatment at a temperature near the crystallization temperature, and thus superior soft magnetism (low coercive force, high magnetic permeability) can be obtained.

### EXAMPLES

Next, the present invention will be described in more detail with reference to examples, but the present invention is not limited thereto.

### Examples 1 to 9, Comparative Examples 1 to 4

Using alloys of compositions shown in Table 1 below, thin strips of amorphous phase with a thickness of 0.02 mm were prepared by a single roll liquid quenching method. Subsequently, the thin strips were annealed in a nitrogen gas atmosphere. Annealing temperature and annealing time are as shown in Table 1. Annealing in the examples was performed at a temperature lower by 20 K than Tg. Here, Tx1 shown in column of the annealing temperature in the comparative examples is a first crystallization start temperature when a differential scanning calorific value is measured at a temperature rising rate of 0.67 K/s. That is, annealing in the comparative examples was performed at a temperature lower by 20 to 35 K than Tx1.

### [Alloy Structure]

The structure of the annealed alloy in which only a broad peak appears in an X-ray diffraction pattern was confirmed to be Am (amorphous). In Table 1 below, “Am+bcc” is one in which a sharp peak appeared in addition to a broad peak in an X-ray diffraction pattern, and was confirmed to be a state in which Am and a bcc phase (crystalline phase) of Fe coexist.

### [Confirmation of Glass Transition Temperature (Tg)]

Tg was confirmed by start temperature of an endothermic reaction on a DSC curve measured at a temperature rising rate of 20 to 40 K/min using a differential scanning calorimeter (DSC).

[Measurement of Bs (saturation magnetic flux density)]

Bs was measured in a 2 T magnetic field using a vibrating sample magnetometer (VSM).

### [Measurement of Hc (Coercive Force)]

Hc was measured at a magnetic load up to 200 A/m using a magnetic field-magnetic (B-H) loop analyzer.

### [μe (Effective Magnetic Permeability)]

μe was measured in a wide range from 0.1 kHz to 10 MHz in an AC magnetic field of 5 mA/m using an impedance analyzer. Table 1 shows measurement results at 1 kHz. As the sample, a thin strip sample with a length of 7 to 9 cm or a thin strip ring-shaped sample with a length of 60 cm was used.

The results are shown in Table 1.

TABLE 1

| | | | Glass | | | | | |
|---|---|---|---|---|---|---|---|---|
| | | | transition | Annealing | Annealing | | | |
| | | Alloy | temperature | temperature | time ta | Bs | Hc | μe |
| | Alloy (atomic %) | structure | Tg (K) | Ta (K) | (min) | (T) | (A/m) | (1 kHz) |
| Example 1 | (Fe_{0.5}Ni_{0.5})₇₈ B₁₃ P₅ Si₃ C₁ | Am | 721 | 701 | 20 | 0.87 | 0.63 | 81000 |
| Example 2 | (Fe_{0.4}Ni_{0.6})₇₈ B₁₃ P₅ Si₃ C₁ | Am | 716 | 696 | 30 | 0.68 | 0.82 | 71000 |
| Example 3 | (Fe_{0.5}Ni_{0.5})₇₉ B₁₂ P₅ Si₃ C₁ | Am | 704 | 684 | 20 | 0.94 | 0.60 | 80000 |
| Example 4 | (Fe_{0.4}Ni_{0.6})₇₉ B₁₂ P₅ Si₃ C₁ | Am | 700 | 680 | 30 | 0.74 | 0.89 | 68000 |
| Example 5 | (Fe_{0.5}Ni_{0.5})₈₀ B_{11.5} P_{4.5} Si₃ C₁ | Am | 687 | 667 | 20 | 1.03 | 0.75 | 72000 |
| Example 6 | (Fe_{0.4}Ni_{0.6})₈₀ B_{11.5} P_{4.5} Si₃ C₁ | Am | 681 | 661 | 30 | 0.94 | 0.93 | 63000 |
| Example 7 | (Fe_{0.5}Ni_{0.5})₈₁ B_{11.5} P_{4.5} Si_{2.5} C_{0.5} | Am | 670 | 650 | 20 | 1.11 | 0.84 | 66000 |
| Example 8 | (Fe_{0.4}Ni_{0.6})₈₁ B_{11.5} P_{4.5} Si_{2.5} C_{0.5} | Am | 663 | 643 | 20 | 1.02 | 0.98 | 57000 |
| Example 9 | (Fe_{0.5}Ni_{0.5})₈₁ B₁₂ P₄ Si_{2.5} C_{0.5} | Am | 674 | 654 | 20 | 1.28 | 0.97 | 53000 |
| Comparative | (Fe_{0.7}Ni_{0.3})₇₈ B₁₃ P₅ Si₃ C₁ | Am | No Tg | T_{X}1 − 35 K | 20 | 1.25 | 5 | 14000 |
| Example 1 | | | | | | | | |
| Comparative | (Fe_{0.8}Ni_{0.2})₇₈ B₁₃ P₅ Si₃ C₁ | Am | No Tg | T_{X}1 − 20 K | 15 | 1.36 | 7 | 13500 |
| Example 2 | | | | | | | | |
| Comparative | (Fe_{0.6}Ni_{0.4})₇₈ B₉ P₇ Si₅ C₁ | Am | No Tg | T_{X}1 − 30 K | 10 | 1.02 | 4 | 38000 |
| Example 3 | | | | | | | | |
| Comparative | (Fe_{0.5}Ni_{0.5})₈₃ B₈ P₅ Si₃ C₁ | Am + bcc | No Tg | T_{X}1 − 20 K | 20 | 1.65 | 14 | 8500 |
| Example 4 | | | | | | | | |

As shown in Table 1, it was confirmed that all the samples shown in Examples 1 to 9 were all composed of only an amorphous phase. Moreover, they had a saturation magnetic flux density (Bs) of 0.6 T or more, and a coercive force (Hc) of 1 A/m or less. In addition, it was confirmed that they had an effective magnetic permeability (μe) at 1 kHz of 50,000 or more, and had extremely good soft magnetic properties.

In Comparative Examples 1 to 4, no glass transition point (Tg) was observed. Further, these comparative examples could not obtain a low coercive force, and could obtain only an effective magnetic permeability much lower than 50,000.

Comparative Examples 1 and 2 are alloys that deviate from the blending ratio range of Fe and Ni in the formula (I), and Comparative Example 4 is an alloy that deviates from the ranges of a and b (atomic%). Comparative Example 3 is an alloy that deviates from the scope of the present invention except for a and e (atomic %).

The super soft magnetic Fe-based amorphous alloy of the present invention has a low coercive force and a high saturation magnetic flux density, and also has extremely excellent effective magnetic permeability, and thus, can be suitably applied to low loss inductors (for example, ultra high frequency inductors for smartphones of 100 kHz or more), magnetic sensors, magnetic shields, magnetic antennas, and the like, as an excellent super soft magnetic material.

What is claimed is:

1. A super soft magnetic Fe-based amorphous alloy represented by a composition formula of the following formula (I):
(Fe_{1-X}Ni_{X})ₐB_{b}P_{c}Si_{d}Ce (I)
wherein 0.45≤X≤0.65,
a, b, c, d, and e each represent atomic%, 78≤a≤82, 10≤b≤13, 3≤c≤5, 2≤d≤4, 0.5≤e≤1, and a+b+c+d+e=100.

2. The super soft magnetic Fe-based amorphous alloy according to claim 1, wherein B/Si is 3 to 6 (atomic % ratio) in the formula (I).

3. The super soft magnetic Fe-based amorphous alloy according to claim 1, wherein (B+P+C)/Si is 4 to 8 (atomic % ratio) in the formula (I).

4. The super soft magnetic Fe-based amorphous alloy according to claim 1, wherein (B+C)/(P+Si) is larger than 1.4 (atomic % ratio) in the formula (I).

5. The super soft magnetic Fe-based amorphous alloy according to claim 1, which has an effective magnetic permeability (μe(1 kHz)) of 50,000 or more.

6. The super soft magnetic Fe-based amorphous alloy according to claim 1, which has a glass transition temperature (Tg) in a region lower than crystallization start temperature (Tx) in heat treatment.

7. The super soft magnetic Fe-based amorphous alloy according to claim 2, wherein (B+P+C)/Si is 4 to 8 (atomic % ratio) in the formula (I).

8. The super soft magnetic Fe-based amorphous alloy according to claim 2, wherein (B+C)/(P+Si) is larger than 1.4 (atomic % ratio) in the formula (I).

9. The super soft magnetic Fe-based amorphous alloy according to claim 2, which has an effective magnetic permeability (μe(1 kHz)) of 50,000 or more.

10. The super soft magnetic Fe-based amorphous alloy according to claim 2, which has a glass transition temperature (Tg) in a region lower than crystallization start temperature (Tx) in heat treatment.

11. The super soft magnetic Fe-based amorphous alloy according to claim 3, wherein (B+C)/(P+Si) is larger than 1.4 (atomic% ratio) in the formula (I).

12. The super soft magnetic Fe-based amorphous alloy according to claim 3, which has an effective magnetic permeability (μe(1 kHz)) of 50,000 or more.

13. The super soft magnetic Fe-based amorphous alloy according to claim 3, which has a glass transition temperature (Tg) in a region lower than crystallization start temperature (Tx) in heat treatment.

14. The super soft magnetic Fe-based amorphous alloy according to claim 4, which has an effective magnetic permeability (μe (1 kHz)) of 50,000 or more.

15. The super soft magnetic Fe-based amorphous alloy according to claim 4, which has a glass transition temperature (Tg) in a region lower than crystallization start temperature (Tx) in heat treatment.

16. The super soft magnetic Fe-based amorphous alloy according to claim 5, which has a glass transition temperature (Tg) in a region lower than crystallization start temperature (Tx) in heat treatment.
